(19) United States
(12) Patent Application Publication
(10) Pub. No.: US 2010/0088755 A1
(43) Pub. Date: Apr. 8, 2010

(54) Access management for devices in communication networks

(75) Inventor: Christian Gotare, Getinge (SE)

Correspondence Address: ERICSSON INC., 6300 LEGACY DRIVE, M/S EVR 1-C-11, PLANO, TX, 75024, US

(73) Assignee: TELEFONAKTIEBOLAGET L M ERICSSON (PUBL), Stockholm (SE)

(21) Appl. No.: 12/521,287

(22) PCT Filed: Dec. 29, 2006
(86) PCT No.: PCT/SE2006/001515

§ 371 Date: Jun. 25, 2009

(51) Int. Cl. G06F 21/00; H04W 12/00

(52) U.S. Cl. 726/11; 726/3; 370/328

(57) ABSTRACT

The invention relates to a terminal a node and a method for terminating communication between a communication network (200) and a device (340) connected to the communication network (120, 200) via an access manager (330, 330′), which access manager (330, 330′) is arranged to operatively accept communication between the network (200) and the device (340) depending on a received identifier, wherein the network (200), node (210, 220) or terminal (290) is arranged to operatively provide said access manager (330, 330′) with an identifier associated with the terminal (290) being operatively connected to the network (200). The termination is preformed by the steps of detecting that said terminal (290) has terminated its activities; and transmitting a message from the network (200) to the access manager (30, 330′) instructing the access manager (330, 330′) to deny communication from the device (340) to the terminal (290) via the network (200).

### TECHNICAL FIELD

The present invention is directed to communication between devices in communication networks. Particular aspects of the invention are directed to access management for devices in communication networks. Even more particular aspects of the invention are directed to address management for devices in telecommunication networks.

### BACKGROUND OF THE INVENTION

Over the years there has been an ever increasing development of different communication networks covering a vast spectrum within such areas as e.g. computer networks and telecommunication networks etc. Communication networks may be of different scale such as e.g. Personal Area Network (PAN), Local Area Network (LAN), Campus Area Network (CAN), Metropolitan Area Network (MAN) or Wide Area Network (WAN) etc. Typically, communication networks are supporting and/or utilizing one or several different functional relationships such as e.g. Client-Server relations and/or Peer-to-Peer relations etc. Furthermore, communication networks are usually based on one or several different topologies such as e.g. bus-networks, star-networks, ring-networks, mesh-networks, star-bus networks and/or tree topology networks etc. The networks may be based on wired communication and/or wireless communication. It should be added that in many occasions there are no clear boundaries between different communication networks. The networks may e.g. be mixed and/or connected to each other.

Suppliers and operators of modern communication networks have become increasingly aware of the vital roles of Operations System Support (OSS) and Business Support Systems (BSS). In particular, the BSS and similar business-related systems have became increasingly interesting as the competition and the need for improved revenues has intensified the demand for more and improved services.

The particular interest in the BSS and similar business related systems can at least partly be explained in that these systems are used by operators to run the business operations in their communication networks. In other words, these systems play a key role in managing the increasing number of improved services needed in the intensified competition.

In this connection it should be emphasized that the term BSS is not limited to telecommunication networks. On the contrary, the term is applicable to all communication networks in which different services are provided to various customers, including but not limited to physical persons as well as legal persons in all sectors. Activities that are typically handled by BSS and other business related systems are e.g. taking a customer's order, managing customer data, managing order data, billing, rating, and offering Business-to-Business (B2B) and Business-to-Customer (B2C) services etc. The BSS and OSS platforms may be linked in the need to support various end to end services and each area may have its own data and service responsibilities.

In an environment of intensified competition it is essential that the provided services—new and existing—can be trusted by the consumers. The services should therefore meet high security standards regarding confidentiality, data integrity, accountability, availability and controlled access etc. Confidentiality will e.g. ensure that transmitted or stored data is only revealed to the intended audience. Confidentiality of entities is also referred to as anonymity. Data integrity will e.g. ensure that it is possible to detect any modification of data. Amongst other things this requires that the creator of a certain data can be identified. Accountability will e.g. ensure that the entity responsible for any communication event can be identified. Availability will e.g. ensure that the provided services are available and that the services are functioning correctly. Controlled access will e.g. ensure that only authorized entities are able to access certain services or information.

In this connection it has become apparent that most, if not all, communication networks of today are displaying weak functionality regarding security matters such as accountability and controlled access and the like. The problem is articulated in access-management systems, e.g. in firewall systems and similar access managers. For example, a first device on one side of an access manager may end its communication with a second device on the other side of the access manager, and the second device may nevertheless continue its communication and/or continue to keep the session active in some other way under a certain period, e.g. a timeout period.

A situation in which the second device continues its communication or keeps the session active even though the first device has ended the activities at its side is indeed undesired. For example, traffic flowing from the second device even though the first device has ended its activities will typically result in an over-billing. Naturally, this is not acceptable from a billing point of view. Furthermore, if the second device keeps the session active even though the first device has ended its activities the active session may be used by others that are not authorized to do so, e.g. by someone that has monitored the traffic so as to impersonate the legitimate user and take its place when the legitimate user ends his part of the session.

In the light of the above there seems to be a need for an improved access management for devices in communication networks.

### SUMMARY OF THE INVENTION

The present invention is directed to solving the problem of providing an improved access management for devices in communication networks.

One object of the present invention is thus to provide an improved access management for devices in communication networks.

This is accomplished by a first aspect of the present invention providing a communication terminal arranged to operatively communicate with a device via a communication network and an access manager. The access manager is arranged between the network and the device for operatively accept communication between the terminal and the device depending on a received identifier. The communication terminal is arranged to operatively provide the access manager with an identifier associated with the terminal. In particular, the communication terminal is characterized in that it is arranged to terminate an accepted communication by operatively transmit a message to the access manager instructing the access manager to deny communication from the device to the terminal via the network.

A second aspect of the invention is directed towards a communication terminal including the features of the first aspect. The second aspect is characterized in that the terminal is further arranged to terminate an accepted communication by operatively transmit a message to the access manager instructing the access manager to deny communication from the terminal to the device.

A third aspect of the invention is directed towards a communication terminal including the features of the first aspect or the second aspects. The third aspect is characterized in that the terminal is a client and the device is a server.

A fourth aspect of the invention is directed towards a communication terminal including the features of the first aspect the second aspect or the third aspect. The fourth aspect is characterized in that the terminal is a telecommunication terminal and the network is a telecommunication network.

The object mentioned above is also achieved by a fifth aspect of the present invention providing a node in a communication network, which node is arranged to operatively communicate with a device via an access manager. The access manager is arranged between the network and the device for operatively accept communication between the network and the device depending on a received identifier. The node is arranged to operatively provide the access manager with an identifier associated with a terminal being operatively connected to the network and the node. The node is particularly characterized in that it is arranged to terminate an accepted communication by operatively transmit a message to the access manager instructing the access manager to deny communication from the device to the terminal via the network.

A sixth aspect of the invention is directed towards a node including the features of the fifth aspect. The sixth aspect is characterized in that the node is further arranged to terminate an accepted communication by operatively transmit a message to the access manager instructing the access manager to deny communication from the terminal to the device via the network.

A seventh aspect of the invention is directed towards a node including the features of the fifth or the sixth aspects. The seventh aspect is characterized in that the network is a telecommunication network.

An eight aspect of the invention is directed towards a node including the features of the fifth, sixth or seventh aspect. The eight aspect is characterized in that the node is a GPRS Support Node (GGSN).

A ninth aspect of the invention is directed towards a node including the features of the fifth, sixth, seventh or eight aspect. The ninth aspect is characterized in that the node is arranged to operatively communicate with an access manager in the form of a firewall.

The object mentioned above is also achieved by a tenth aspect of the present invention providing a method for terminating communication between a communication network and a device being connected to the communication network via an access manager. The access manager is arranged to operatively accept communication between the network and the device depending on a received identifier, wherein the network is arranged to operatively provide said access manager with an identifier associated with a terminal being operatively connected to the network.

The method is particularly characterized by the steps of:
detecting that that said terminal has terminated its activities; and
transmitting a message from the network to the access manager instructing the access manager to deny communication from the device to the terminal via the network.

An eleventh aspect of the invention is directed towards a method including the features of the tenth aspect. The eleventh aspect is characterized by the further steps of transmitting a message from the network to the access manager instructing the access manager to deny communication from the terminal to the device via the network.

A twelfth aspect of the invention is directed towards a method including the features of the ninth or tenth aspect. The twelfth aspect is characterized by the further steps of providing the access manager with a filter-profile for the terminal from a database in the network. The filter-profile comprises conditions to be fulfilled for the access manager to accept communication for the terminal in question.

A thirteenth aspect of the invention is directed towards a method including the features of the ninth, tenth or eleventh aspect. The thirteenth aspect is characterized in that: the access manager is a firewall.

Further advantages of the present invention and embodiments thereof will appear from the following detailed description of the invention.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

FIG. 1 is a schematic illustration of a first exemplifying communication network

FIG. 2 is a schematic illustration of a second exemplifying communication network

FIG. 3 is a schematic illustration of a first use-case

FIG. 4 is a schematic illustration of a second use-case

### DETAILED DESCRIPTION OF PREFERRED EMBODIMENTS

### Structure of Preferred Embodiments

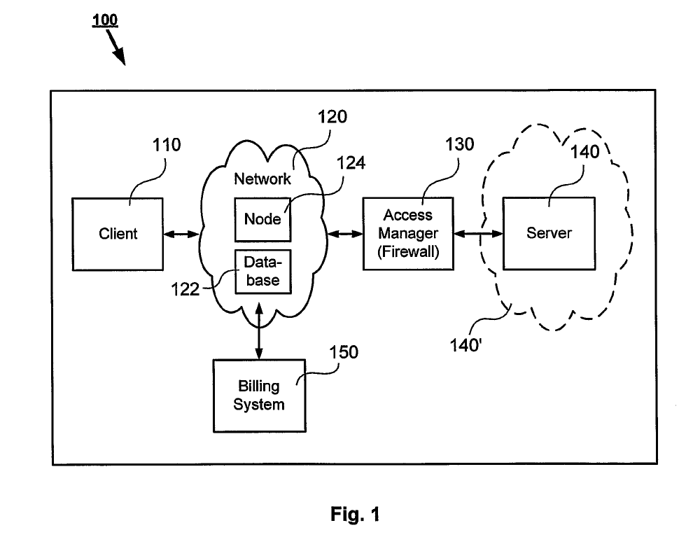

FIG. 1 illustrates a first exemplifying communication network system 100 according to an embodiment of the invention. The exemplifying network system 100 comprises a client 110, a communication network 120, an access-management system 130, a server 140 and a billing system 150. It should be understood that there may be more than one communication network 120, more than one access-management system 130, more than one server 140 and possibly more than one billing system 150.

The client 110 in the exemplifying communication network system 100 in FIG. 1 is preferably a terminal in the form of a computer or a computer system or similar being arranged to operatively communicate with the server 140 via the network 120. The client 110 may e.g. be a fat client (also known as a thick client) arranged to perform the main parts of any processing and the like without relying on the server 140. A fat client is typically a personal computer or a similar intelligent device comprising processing power for running various applications. However, the client 110 may alternatively be a thin client, which uses the resources of the server 140 for the main part of any processing. The tasks of a thin client are generally limited to providing commands to the server 140 and displaying images etc received from the server 140. A thin client may e.g. be a simple combination of a monitor and a keyboard connected to the network 120. It should be added that the client 110 may be a hybrid between a thick client and a thin client, in which case the main processing is typically done locally in the client while the storage etc is done on the server 140. This approach offers features from both the fat client (multimedia support, high performance) and the thin client (high manageability, flexibility).

The communication network 120 in the exemplifying communication network system 100 is preferably a packet switched network being arranged to operatively communicate data between the client 110 and the server 140. The packet switched network 120 may e.g. be the Internet or a similar network. The Internet and similar networks can be perceived as a collection of interconnected computers and computer networks or similar being linked by copper wires, fiber-optic cables, wireless connections etc. The devices in such networks are typically communicating by means of an IP (Internet Protocol) and a TCP (Transmission Control Protocol) as is well known in the art. As an alternative and/or possibly as a complement to the TCP some networks may use the User Datagram Protocol (UDP) or the Stream Control Transmission Protocol (SCTP) or some other similar protocol that is likewise well known in the art. However, even if packet switched networks as the Internet and similar are preferred it should be emphasized that other communication networks are clearly conceivable.

The access-management system 130 in the exemplifying communication network system 100 is preferably a firewall arranged between the network 120 and the server 140 so as to operatively communicate data between the network 120 and the server 140. The firewall 130 is utilized to increase the security in the communication between the server 140 and the communication network 120. It should be emphasized that the presence of a firewall in certain embodiments does not preclude that the invention can be implemented by means of other access managers such as gateways and/or routers etc.

Typically, a firewall provides a single point of defense between two networks or similar, i.e. it can protect one network from the other. A firewall can be a simple packet filter firewall or similar that filters all incoming packets by comparing the packets against defined rules relating to a command set for one or more low-level protocols, e.g. such as the IP (Internet Protocol) and/or the TCP (Transfer Control Protocol) or similar. Packets are either denied and dropped or accepted and passed for delivery to the secured network. The packets can e.g. be denied or accepted depending on the address the data is coming from (source IP-address) and/or the address the data is going to (destination IP-address). Other firewalls may be more complex multi-computer, multi-router solutions that combine packet filtering and application-level proxy services that can filter on the content of the traffic. For example, a circuit level firewall may validate that a packet is either a connection request or a data packet belonging to a connection, or virtual circuit, between two peer transport layers. When validating a session, a circuit level firewall may e.g. examine each connection setup to ensure that it follows a legitimate handshake for the transport layer protocol being used. In such cases the data packets are typically not forwarded until the handshake is completed. A more advanced application layer firewall may evaluate network packets for valid data at the application layer before allowing a connection. It may e.g. examine the data in all network packets at the application layer and maintain complete connection state and sequencing information. In addition, an application layer firewall may validate other security items that only appear within the application layer data, e.g. such as user passwords and service requests. An even more advanced dynamic packet filter firewall may be provided with firewall technology that allows modification of the security rules on the fly.

It is preferred that the firewall 130 shown in FIG. 1 is a packet filter firewall or similar that is at least capable of filtering packets depending on the address the data is coming from (source IP-address) and/or the address the data is going to (destination IP-address) as described above. However, this does not preclude that the firewall 130 comprises one or more additional technologies, e.g. one or more of the technologies comprised by circuit level firewalls, application layer firewalls, and/or dynamic packet filter firewalls as briefly described above.

The server 140 in the exemplifying communication network system 100 shown in FIG. 1 is preferably a computer or similar being arranged to operatively communicate with the client 110 via the firewall 130 and via the communication network 120. It is even more preferred that the server 140 is a computer system that operates continuously on a computer network 140′ and waits for requests for services from other computers such as the client 110. The physical structure of the server 140 is preferably similar to general-purpose computers, although the hardware configurations may be particularly optimized to fit the particular role of the server 140. Hence, the hardware may be identical or nearly identical to that in standard desktop PCs or similar. However, the software and particularly the operation system that run on the server 140 are typically different from those used on desktop computers and workstations. It should be added that the computer network 140′ may be a packet switched network such as the Internet or similar. For example, the computer network 140′ may be the Intranet of a certain company. However, other suitable networks may be used.

A typical application may e.g. use the server 140 as a file-server that can be accessed by clients such as the client 110 or similar. The server 140 may then provide files that can be downloaded to the client 110 upon a request from the client 110. The files may e.g. be document-files, sound-files, image-files and/or movie-file or similar. However, the server 140 is not limited to a file-server or to applications based on a file-server. On the contrary, the server 140 may be any of a vast spectrum of well known servers supporting a vast spectrum of applications providing a vast spectrum of services. For example, in case the server 140 is a server connected to the Internet it may support any of all the applications and services that can be provided by and reached via a webpage.

The billing system 150 in the exemplifying communication network system 100 shown in FIG. 1 is preferably a computer system or similar being arranged to operatively communicate with the devices (e.g. nodes) in the communication network 120 and/or with the server 140 via the network 120. It is preferred that the billing system 150 is centralized, which enables the billing system 150 to handle billing issues for a plurality of clients and/or servers or similar being connected to the communication network 120.

The billing may e.g. be based on metered time or transferred packets etc. The metered time may e.g. correspond to the period during which a client is connected to a server or some other usage period during which a session or similar is active. The transferred packets may e.g. correspond to the number of packets or similar communicated between a client and a server or similar. The amount of used time and/or the number transferred packets and other parameters needed for charging a user of a service are typically registered and/or collected and reported to the billing system 150 by suitable devices (e.g. suitable nodes) in the communication network 120 through which the session or similar is established and the packets or similar are flowing.

From the above the observant reader realizes that a centralized billing system as the billing system 150 in FIG. 1 is exposed to inaccurate billing in certain situations. For example, if traffic from the server 140 flows through the firewall 130 and into the network 120 even though the client 110 has terminated its activities at its side this will typically result in an over-billing. For example, the server 140 may continue to transmit packets to the client 110 via the network 120 during a timeout period. These packets may be counted by devices in the network 120 and reported to the billing system 150 even though none of these packets were received by the client 110. The situation is the same if the billing is based on metered time that is registered by devices in the network 120.

Furthermore, if the server 140 and/or the computer network 140′ is allowed to maintain an active session or similar with the network 120 even though the client 110 has ended the activities at its end the active session may be used by unauthorized entities, e.g. by someone that has monitored the session traffic so as to impersonate the legitimate user and take its place when the legitimate user ends his part of the session.

Neither the possibility of an inaccurate billing nor active sessions or similar are desired in modern competitive communication networks. A remedy to this according to embodiments of the present invention will be discussed below in connection with the function of embodiments of the invention.

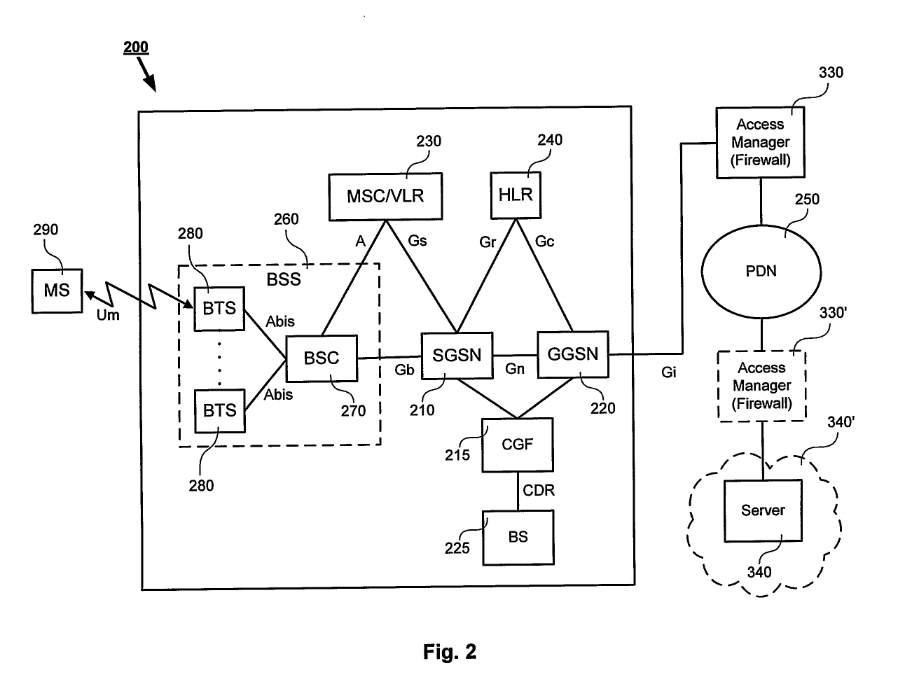

The attention is now directed to a second exemplifying communication network 200 according to an embodiment of the invention as illustrated in FIG. 2. In fact, FIG. 2 is a schematic overview of an exemplifying telecommunication network in the form of a General Packet Radio Service system (GPRS system) in which various network elements and interfaces are shown. The structure and operation of a general GPRS system is well known by those skilled in the art and it needs no detailed explanation. More information about GPRS systems and similar systems the UMTS can e.g. be found in the specifications released by the 3^{rd} Generation Partnership Project (3GPP), se e.g. www.3gpp.orq. However, a brief overview of a GPRS network is given below. Before we proceed it should be emphasized that the invention is by no way limited to a GPRS network or similar. On the contrary, the invention can be implemented in most telecommunication systems of today, e.g. such as GSM, EDGE, CDMA, WCDMA and the HSDPA and similar.

The main Core Network (CN) elements in the GPRS network 200 are the Serving GPRS Support Node (SGSN) 210, the Gateway GPRS Support Node (GGSN) 220, and upgraded location registers such as the Visitor Location Register (VLR) 230 and the Home Location Register (HLR) 240. A SGSN 210 and a GGSN 220 may be connected directly and/or through intermediate routers and switches to form CN. The CN is used as the interface between the GPRS Radio Access Network (RAN) and external data networks such as e.g. a Public Data Network (PDN) 250 as shown in FIG. 2. The Internet is an example of a well known and common PDN. The point of contact to external networks—such as e.g. the Internet etc—is realized through the GGSN 220 using the GPRS Gi-interface. At the other end the SGSN 210 interfaces with the RAN through the GPRS Gb-interface, which RAN e.g. provides mobility management and call signaling functions etc. Typically, the RAN comprises one or several Base station Sub-Systems (BSS) 260, which in turn comprises one or several Base Station Controllers (BSC) 270 connected to a plurality of Base Transmission Stations (BTS) 280 via a GPRS Abis-interface. The BTS is in turn serving one or several Mobile Stations (MS) 290 via a GPRS Urn-interface, which is an air interface. The SGSN 210 maintains signaling connections with the HLR 240 and a Mobile Switching Centre (MSC) and the VLR 230 through the GPRS Gs-interface and the GPRS Gr-interface respectively. The GGSN 220 maintains signaling connections with the HLR 240 through the GPRS Gc-interface. The BSC 270 maintains signaling with the MSC/VLR 230 through the GPRS A-interface. The interconnections between the SGSN 210 and GGSN 220 are implemented through the GPRS Gn-interface.

The CN in GPRS can e.g. use the Internet Protocol (IP) as the protocol in the network layer. The protocols used in the transport layer can e.g. be the Internet User Datagram Protocol (UDP) for IP services and the Internet Transmission Control Protocol (TCP) for services which require delivery guarantee such as X.25 services.

The above description of the GPRS network 200 corresponds in general to the 3GPP standardization and particularly to the specifications in the 3GPP 28-series and 48-series regarding Signal Protocols RSS-CN.

In addition, as can be seen in FIG. 2, the GPRS network 200 comprises a Charging Gateway Function (CGF) 215 and a Billing System (BS) 225. The CGF 215 provides a mechanism for transfer of charging information from the SGSN 210 and the GGSN 220 to the network operator's chosen BS 225. This concept enables an operator to have just one logical interface between the GSNs 210, 220 in CN and the BS 225. Typical functions of the CGF 215 are related to the handling of the so-called Call Detail Records (CDR), such as e.g. collecting GPRS CDRs from the GPRS nodes, generating CDRs, intermediate CDR storage buffering and transfer of the CDR data to the BS 225.

The above description of an exemplifying GPRS billing system corresponds in general to the 3GPP standardization and particularly to the specifications in the 3GPP 32-series and 52-series regarding OAM&P and Charging.

The embodiment of the present invention described above with reference to FIG. 2 comprises at least one access manager 330 that is preferably arranged between the GGSN 220 and the PDN 250 comprising or being connected to a server 240. In addition or alternatively, an access manager 330′ may e.g. be arranged between the PDN 250 and the server 340, or between the PDN 250 and a computer network 340′ in which the server 340 is arranged. It should be noted that the point of contact between the GPRS network 200 and external networks such as the PDN 250 or similar is realized through the GGSN 220 using the GPRS Gi-interface.

It is preferred that the access manager 330 in FIG. 2 is the same as or similar to the firewall 130 described above with reference to FIG. 1. Hence, it is preferred that the firewall 330 in FIG. 2 is a packet filter firewall or similar that is capable of filtering packets based on the address the data is coming from (source IP-address) and/or the address the data is going to (destination IP-address) as described above. However, this does not exclude that the firewall 330 comprises one or more addition technologies, e.g. one or more of the technologies comprised by circuit level firewalls, application layer firewalls, and/or dynamic packet filter firewalls as briefly described above.

As briefly mentioned above and as can be seen in FIG. 2 it is preferred that the PDN 250 is connected to or comprises a server 340. The server 340 is preferably a computer or similar being arranged to operatively communicate with the MS 290 in the GPRS network 200. It is even more preferred that the server 340 is a computer system that operates continuously on a computer network 340′ and waits for requests for services from other computers and/or terminals such as the MS 290 shown in FIG. 2. In fact the server 340 may be the same as the server 140 described above with reference to FIG. 1. It should be added that the computer network 340′ may be a part of the PDN 250 or a separate computer network as indicated in FIG. 2.

The observant reader realizes that the MS 290 shown in FIG. 2 is a cell phone or a similar terminal being arranged to operatively communicate with the server 340 by establishing a contact with the GPRS network 200, which in turn establishes contact with the firewall 330 via the GGSN 220, whereupon the firewall 330 forwards the communication to the server 340, provided that the communication from the particular MS 290 is accepted. The communication may e.g. be forwarded to the server 340 via a PDN 250 as illustrated in FIG. 2.

The structures and functions for enabling a MS 290 to communicate with a server 340 via a GPRS network 200 and a firewall 330 is well known in the art and it needs no further description. This is the same in case the firewall 330 is connected to a PDA 250 or similar comprising or being connected to the server 340 as schematically illustrated in FIG. 2.

### Function of Preferred Embodiments

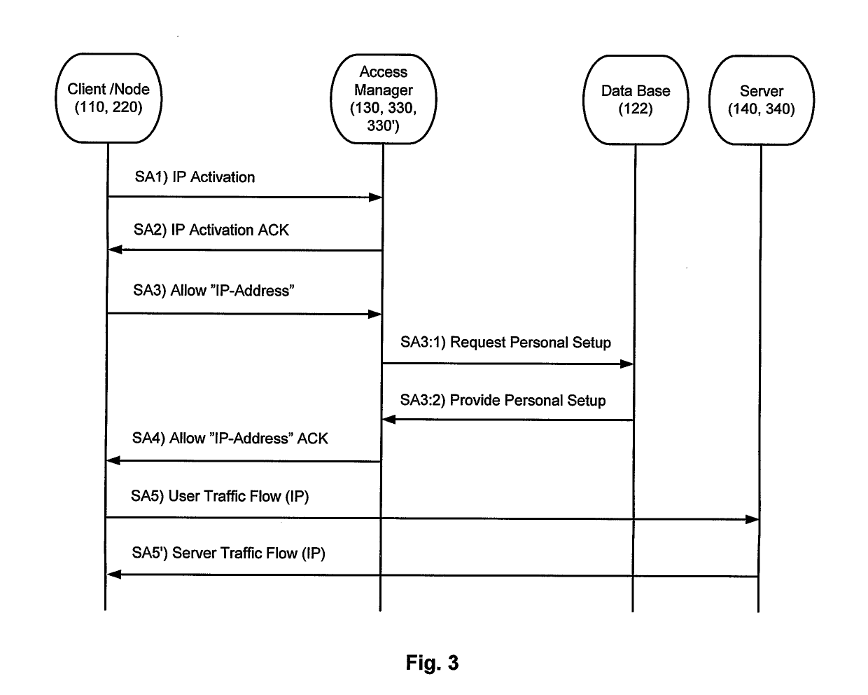

FIG. 3 illustrates an exemplifying use-case for establishing communication between the client 110 and the server 140 in the communication network 100 shown in FIG. 1.

In a first step SA1 it is preferred that the client 110 starts a new connection or similar by sending an activation message to the firewall 130 via the network 120. The activation message may be a simple synchronization message or the like. However, it is preferred that the activation message is an initiation message or an initiation packet or similar intended to establish whether the firewall 130 is available for handling incoming traffic from the client 110. The activation message can e.g. be sent in the form of one or several packets having one or more bits set, which bit(s) can be read and responded to by the firewall 130.

In a second step SA2 it is preferred that the firewall 130 replies with a message to the client 110, at least in case the firewall 130 is available for communicating with the client 110 as required. For example, this can be done by the firewall 330 sending a packet to the client 110 in which one or several acknowledge bits that are set, as is well known in the art.

In a third step SA3 it is preferred that the client 110 sends an identifying message to the firewall 130. For example, this can be done by the client 110 sending one or several packets to the firewall 130 comprising one or several identifiers associated with the client 110. It is preferred that at lest an source IP-address associated with the client 110 is sent to the firewall 130. It should be added that an identifier may not be unique for the particular client 110. On the contrary, several clients or similar may share the same identifier. This may e.g. be the case when they share the same privileges at the firewall 130. The individual clients or similar sharing the same identifier can be identified by other means if necessary, e.g. by means of further identifiers.

In a first auxiliary step SA3:1 according to an embodiment of the present invention it is preferred that the firewall 130 sends a request to a database 122 or similar—e.g. an Authentication, Authorization and Accounting system (AAA-system) or similar—asking for information regarding the user-filter-profile to be used in the firewall 130 for the specific identifier received by the firewall 130 from the client 110 in step S3 above. For example, this can be done by the firewall 130 sending one or several packets to the AAA-database comprising one or several identifiers associated with the client 110, e.g. such as a source IP-address. It should be added that the AAA-database may be a part of the communication network 120 and/or the billing system 150.

In a second auxiliary step SA3:2 it is preferred that the AAA-database or similar replies by providing a personalized user-filter-profile to the firewall 130. This can be done by the AAA-database sending a message to the firewall 130 comprising information about the user-filter-profile to be used in the firewall 130 for the client 110 associated with the identifier mentioned in step S3:1, e.g. the source IP-address or similar. The user-filter-profile may e.g. be stored in the AAA-database and downloaded to the firewall 130. Alternatively, the user-filter-profile may be stored in the firewall 130 so as to be activated by the message from the AAA-database. A user-filter-profile may e.g. comprise the conditions to be fulfilled when the firewall 130 is to accept and allow communication for a specific identifier associated with the client 110. Moreover, depending on the user-filter-profile the firewall 130 may require a more precisely defined behavior of the client 110 and the server 140, as indicated in the discussion above regarding circuit level firewalls, application layer firewalls, and/or dynamic packet filter firewalls as briefly described above.

The steps SA3:1 and SA3:2 as described above provide a close to personal firewall behavior providing an enhanced flexibility. In addition, several firewalls may utilize the same AAA-database or similar, which provides a centralized and uniform management of the various user-filter-profiles and similar to be applied by the firewalls.

In a fourth SA4 step it is assumed that the IP-address or a similar identifier associated with the client 140 has been accepted by the firewall 130. It is then preferred that the firewall 130 replies with a message informing the client 110 that the firewall 130 has accepted said identifier. This can e.g. be done by the firewall 130 sending a packet in which one or several acknowledge bits are set.

In a fifth step SA5, SA5′ it is preferred that the connection between the client 110 and the server 140 enters an established state in which communication can flow in at least one and preferably both directions between the client 110 and the server 140. This has been schematically illustrated in FIG. 3 by a first arrow S5 pointing from the client 110 to the server 140 indicating traffic from the client 110 to the server 140 and a second arrow S5′ pointing from the sever 140 to the client 110 indicating traffic from the server 140 to the client 110.

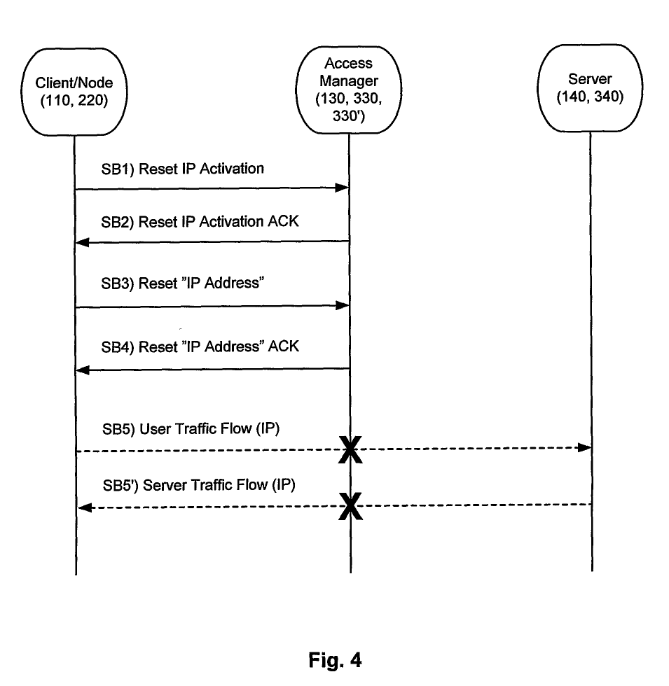

The attention is now directed to FIG. 4 which illustrates an exemplifying use-case for terminating a connection between the client 110 and the server 140 in the exemplifying communication network 100 shown in FIG. 1.

In a first step SB1 it is preferred that the client 110 terminates communication or similar flowing to the server 140 from the client 110 by sending a first reset message or similar to the firewall 130. The reset message is preferably a termination message or similar instructing the firewall 130 to deny or otherwise reject further incoming traffic from the client 110 in question, e.g. reject communication comprising an identifier associated with the client 110. The reset message may e.g. be sent in the form of one or several packets having one or more bits set, which bit(s) can be read and responded to by the firewall 130. Additionally or alternatively said reset message may comprise one or several identifiers associated with the client 110, as discussed above for step SA3 in the connection procedure schematically illustrated in FIG. 3. It should be added that an in alternative embodiment the network 120 and/or a suitable node 124 therein may be arranged to sense or otherwise detect that the client 110 has terminated its activities. The reset message may then be sent to the firewall 130 from the network 120 and/or from a suitable node 124 in the network 120.

In a second step SB2, as shown in FIG. 4, it is preferred that the firewall 130 replies to the network 120 and/or a suitable node 124 therein with a message to inform the client 110 that the firewall 130 will now deny further communication from the client 110. This can e.g. be done by the firewall 130 sending a packet to the client 110 via the network 120 in which packet one or several acknowledge bits are set.

In a third step SB3 it is preferred that the client 110 terminates communication or similar flowing from the server 140 to the client 110 via the network 120 by sending a second reset message or similar to the firewall 130. The reset message is preferably a termination message or similar instructing the firewall 130 to deny or otherwise reject further communication from the server 140 to the client 110, e.g. reject communication comprising an identifier associated with the client 110. The reset message may e.g. be sent in the form of a packet having one or more bits set, which bit(s) can be read and responded to by the firewall 130. Additionally or alternatively said reset message may comprise one or several identifiers associated with the client 110, as discussed above for step SA3 in the connection procedure schematically illustrated in FIG. 3. It should be added that an in alternative embodiment the network 120 and/or a suitable node 124 therein may be arranged to sense or otherwise detect that the client 110 has terminated its activities. The second reset message may then be sent to the firewall 130 from the network 120 and/or from a suitable node 124 in the network 120.

In a fourth step SB4 it is preferred that the firewall 130 replies with a message to inform the client 110 that the firewall 130 will now deny further communication from the client 110. This can e.g. be done by the firewall 130 sending a packet to the client 110 in which one or several acknowledge bits are set.

In a fifth step SA5, SA5′ it is preferred that the connection between the client 110 and the server 140 enters a terminated state in which at least communication from the server 140 to the client 110 via the network 120 is terminated by the firewall 130. It is even more preferred that communication from the server 140 to the client 110 as well as communication from the client 110 to the server 140 is terminated by the firewall 130. This has been schematically illustrated in FIG. 4 by a first arrow SB5 pointing from the client 110 to the server 140, which arrow SB5 has been provided with a cross at the firewall 130 to indicate that traffic from the client 110 to the server is denied or otherwise rejected by the firewall 130. This has also been schematically illustrated in FIG. 4 by a second arrow SB5′ pointing from the server 140 to the client 110, which arrow SB5′ has been provided with a cross at the firewall 130 to indicate that traffic from the server 140 to the client 110 is denied or otherwise rejected by the firewall 130.

To summarize the above description referring to FIG. 3 and FIG. 4 it can be concluded that after step SB1 has been performed no communication from the client 110 will be accepted by the firewall 130. In other words, there is no active session or similar that can be used by unauthorized entities to access the server 140 via the network 110. Hence, this provides an improved access control which ensures that only authorized entities are able to access the server 140.

Similarly, after step SB4 has been performed no communication from the server 140 to the network 120 and the client 110 will be accepted by the firewall 130. In other words, there is no communication flowing from the server 140 into the network 120 that can be metered and/or counted by the billing system 150. Hence, this provides an improved billing functionality with a reduced risk for over billing, i.e. an improved accountability and availability. In particularly, it enables the network 120 to control the billing etc in a manner that is substantially independent from the function of the server 140 and the applications running on the server 140.

It should be added that the steps SB1, SB2, SB3 and SB4 may be performed in another order, e.g. SB3, SB4 and then SB1, SB2. In addition, some of the steps may be exclude by embodiments of the invention. However, it is preferred that at least step SB3 is performed.

Above the use-case in FIG. 3 for establishing a connection and the use-case in FIG. 4 for terminating a connection have been discussed with reference to the exemplifying communication network system 100 in FIG. 1. The exemplifying use-cases in FIG. 3 and FIG. 4 will now be discussed with reference to the exemplifying GPRS network 200 etc shown in FIG. 2.

In a first step SA1, as shown in FIG. 3, it is preferred that the MS 290 starts a new connection or similar by sending an activation message to the firewall 330. The message is preferably sent via the GPRS Um-interface to the GPRS network 200, from which the message is sent by the GGSN 220 to the firewall 330 via the GPRS Gi-interface as is well known in the art. It is preferred that the activation message is an initiation message or an initiation packet or similar intended to establish whether the firewall 330 is available for handling incoming traffic from the MS 290. The activation message may e.g. be sent in the form of one or several packets having one or more bits set, which bit(s) can be read and responded to by the firewall 330.

In a second step SA2 it is preferred that the firewall 330 replies with a message to the GGSN 220 in case the firewall 330 is available for communicating with the MS 290. It is preferred that the GGSN 220 forwards this message to the MS 290. For example, this can be done by the firewall 330 sending a packet to the GGSN 220 in which one or several acknowledge bits that are set, as is well known in the art.

In a third step SA3 it is preferred that the MS 290 sends an identifying message to the firewall 330. For example, this can be done by the MS 290 sending one or several packets to the firewall 330 comprising one or several identifiers associated with the MS 290. It is preferred that at lest a source IP-address associated with the MS 290 is sent to the firewall 330.

Before we proceed it should be added that the first and second auxiliary steps SA3:1 and SA3:1 as described above with reference to the communication network system 100 in FIG. 1 are applicable mutatis mutandis to the GPRS network 200 and the firewall 330 etc in FIG. 2. For example, a database or similar—e.g. an Authentication, Authorization and Accounting system (AAA-system)—can be arranged within the GPRS network 200 in a similar way as the database 122 is arranged in the network 120 as schematically illustrated in FIG. 1. Alternatively, an AAA-database or similar may be connected to the GPRS network 200. As mentioned above, the steps SA3:1 and SA3:2 provide a close to personal firewall behavior providing an enhanced flexibility. In addition, several firewalls may utilize the same AAA-database or similar, which provides a centralized and uniform management of the various user-filter-profiles and similar to be applied by the firewalls.

In a fourth SA4 step it is assumed that the source IP-address or a similar identifier associated with the MS 290 has been accepted by the firewall 330. It is then preferred that the firewall 330 replies with a message informing the MS 290 that the firewall 330 has accepted said identifier. This can e.g. be done by the firewall 330 sending a packet to the GGSN 220 in which one or several acknowledge bits are set. It is preferred that the GGSN 220 forwards this message to the MS 290.

In a fifth step SA5, SA5′ it is preferred that the connection between the MS 290 and the server 340 enters an established state in which communication can flow in at least one and preferably both directions between the MS 290 and the server 340. This has been schematically illustrated in FIG. 3 by a first arrow S5 pointing from the MS 290 to the server 340 indicating traffic from the MS 290 to the server 340 and a second arrow S5′ pointing from the sever 340 to the MS 290 indicating traffic from the server 340 to the MS 290.

The attention is now directed to FIG. 4 which illustrates exemplifying use-case for terminating a connection between the MS 290 and the server 340 connected via the exemplifying GPRS network 200 etc as shown in FIG. 2.

In a first step SB1 it is preferred that the MS 290 terminates communication or similar flowing to the server 340 from the MS 290 via the GPRS network 200. This is preferably done by the MS 290 sending a first reset message or similar via the GPRS Um-interface to the GPRS network 200, from which the reset message is sent by the GGSN 220 to the firewall 330 via the GPRS Gi-interface. The reset message is preferably a termination message or similar instructing the firewall 330 to deny further incoming communication from the MS 290 in question, e.g. reject communication comprising an identifier associated with the MS 290. The reset message may e.g. be sent in the form of one or several packets having one or more bits set, which bit(s) can be read and responded to by the firewall 330. Additionally or alternatively said reset message may comprise one or several identifiers associated with the MS 290. It should be added that an in alternative embodiment the GPRS network 200 and/or the SGSN 210 and/or the GGSN 220 may be arranged to detect that the MS 290 has terminated its activities. This can e.g. be accomplished by receiving said reset message from the MS 290 or by receiving a similar message from a BSS 260 when the MS 290 is considered to have terminated its activities. The reset message or similar may then be sent to the firewall 330 from the GPRS network 200 and/or the SGSN 210 and/or the GGSN 220.

In a second step SB2, as shown in FIG. 4, it is preferred that the firewall 330 replies with a message to inform the GGSN 220 and/or the MS 290 that the firewall 330 will now deny further communication from the MS 290. This can e.g. be done by the firewall 330 sending a packet to the GGSN 220 and/or the MS 290 in which one or several acknowledge bits are set. It is preferred that the GGSN 220 forwards this message to the MS 290 via the GPRS network 200.

In a third step SB3 it is preferred that the MS 290 terminates communication or similar flowing from the server 340 to the MS 290 via the GPRS network 200. This is preferably done by the MS 290 sending a second reset message or similar via the GPRS Um-interface to the GPRS network 200, from which the reset message is sent by the GGSN 220 to the firewall 330 via the GPRS Gi-interface. The reset message is preferably a termination message or similar instructing the firewall 330 to deny or otherwise reject further communication from the server 340 to the MS 290 via the network 200, e.g. reject communication comprising an identifier associated with the MS 290 in question. The reset message may e.g. be sent in the form of a packet having one or more bits set, which bit(s) can be read and responded to by the firewall 330. Additionally or alternatively said reset message may comprise one or several identifiers associated with the MS 290. It should be added that an in alternative embodiment the GPRS network 200 and/or the SGSN 210 and/or the GGSN 220 may be arranged to detect that the MS 290 has terminated its activities. This can e.g. be accomplished by receiving said reset message from the MS 290 or by receiving a similar message from a BSS 260 when the MS 290 is considered to have terminated its activities. The second reset message may then be sent to the firewall 330 from the GPRS network 200 and/or the SGSN 210 and/or the GGSN 220.

In a fourth step SB4 it is preferred that the firewall 330 replies with a message to inform the MS 290 that the firewall 330 will now deny further communication from the MS 290. This can e.g. be done by the firewall 330 sending a packet to the GGSN 220 in which one or several acknowledge bits are set. It is preferred that the GGSN 220 forwards this message to the MS 290 via the GPRS network 200.

In a fifth step SA5, SA5′ it is preferred that the connection between the MS 290 and the server 340 enters a terminated state in which at least communication from the server 340 to the MS 290 via the GPRS network 200 is terminated by the firewall 330. It is even more preferred that communication from the server 340 to the MS 290 as well as communication from the MS 290 to the server 340 is terminated by the firewall 330. This has been schematically illustrated in FIG. 4 by a first arrow SB5 pointing from the MS 290 to the server 340, which arrow SB5 has been provided with a cross at the firewall 330 to indicate that traffic from the MS 290 to the server 340 is denied or otherwise rejected by the firewall 330. This has also been schematically illustrated in FIG. 4 by a second arrow SB5′ pointing from the server 340 to the MS 290, which arrow SB5′ has been provided with a cross at the firewall 330 to indicate that traffic from the server 340 to the MS 290 is denied or otherwise rejected by the firewall 330.

To summarize the above description referring to FIG. 3 and FIG. 4 it can be concluded that after step SB1 has been performed no communication from the MS 290 will be accepted by the firewall 330. In other words, there is no active session or similar that can be used by unauthorized entities to access the server 340 via the GPRS network 200. Hence, this provides an improved access control which ensures that only authorized entities are able to access the server 340.

Similarly, after step SB4 has been performed no communication from the server 340 to the GPRS network 200 and the MS 290 will be accepted by the firewall 330. In other words, there is no communication from the server 340 to the GPRS network 200 that can be metered and/or counted for billing purposes by the BS 225. Hence, this provides an improved billing functionality with a reduced risk for over billing, i.e. an improved accountability and availability. In particularly, it enables the GPRS network 200 to control the billing etc in a manner that is substantially independent from the function of the server 340 and the applications running on the server 340.

It should be added that the steps SB1, SB2, SB3 and SB4 may be performed in another order, e.g. SB3, SB4 and then SB1, SB2. In addition, some of the steps may be exclude by embodiments of the invention. However, it is preferred that at least step SB3 is performed.

The present invention has now been described with reference to exemplifying embodiments. However, the invention is not limited to the embodiments described herein. On the contrary, the full extent of the invention is only determined by the scope of the appended claims.

1. A communication terminal arranged to communicate with a device via a communication network and an access manager, which access manager is arranged between the network and the device to accept communication between the communication terminal and the device depending on a received identifier, wherein said terminal is arranged to operatively provide said access manager with an identifier associated with the terminal, the communication terminal being arranged to terminate an accepted communication by transmitting a message to the access manager instructing the access manager to deny communication from the device to the terminal via said network.

2. The communication terminal in claim 1, wherein the terminal is further arranged to terminate an accepted communication by transmitting a message to the access manager instructing the access manager to deny communication from the terminal to the device.

3. The communication terminal in claim 1 wherein the terminal is a client and the device is a server.

4. The communication terminal in claim 1, wherein the terminal is a telecommunication terminal and the network is a telecommunication network.

5. A node in a communication network arranged to communicate with a device via an access manager, which access manager is arranged between the network and the device for accepting communication between the network and the device depending on a received identifier, wherein the node is arranged to provide said access manager with an identifier associated with a terminal being operatively connected to the network the node being arranged to terminate an accepted communication by transmitting a message to the access manager instructing the access manager to deny communication from the device to the terminal via the network.

6. The node in claim 5, wherein the node is further arranged to terminate an accepted communication by transmitting a message to the access manager instructing the access manager to deny communication from the terminal to the device via the network.

7. The node in claim 5, wherein the network is a telecommunication network.

8. The node in claim 5, wherein the node is a GPRS Support Node.

9. The node in claim 5, wherein the node is arranged to communicate with an access manager in the form of a firewall.

10. A method for terminating communication between a communication network and a device connected to the communication network via an access manager, which access manager is arranged to accept communication between the network and the device depending on a received identifier, wherein the network is arranged to provide said access manager with an identifier associated with a terminal being operatively connected to the network, comprising the steps of:
detecting that said terminal has terminated its activities; and
transmitting a message from the network to the access manager instructing the access manager to deny communication from the device to the terminal via the network.

11. The method in claim 10, further comprising: transmitting a message from the network to the access manager instructing the access manager to deny communication from the terminal to the device via the network.

12. The method in claim 10, wherein providing the access manager with a filter-profile for the terminal from a database in the network, which filter-profile comprises conditions to be fulfilled for the access manager to accept communication for the terminal in question.

13. The method in claim 10, wherein the access manager is a firewall.
